(19) United States
(12) Patent Application Publication
(10) Pub. No.: US 2005/0200749 A1
(43) Pub. Date: Sep. 15, 2005

(54) Multiple switch integrated device of digital camcorder

(75) Inventors: Chang-hee Lee, Suwon-si (KR); Nam-il Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/048,925

(22) Filed: Feb. 3, 2005

(30) Foreign Application Priority Data
Mar. 10, 2004 (KR) 2004-16041

(51) Int. Cl. H04N 5/225

(52) U.S. Cl. 348/374

(57) ABSTRACT

A multiple switch integrated device of a digital camcorder comprises a switch unit having a plurality of switch assemblies mounted on an outer casing of the camcorder to expose their buttons to the outside for controlling the central processing device to perform functions corresponding to operations of the buttons. A plurality of first electric connection parts electrically connects the plurality of switch assemblies to one another in series. A second electric connection part electrically connects with one of the plurality of switch assemblies and includes a connection terminal connected to a socket formed on the main substrate. The first and the second electric connection part can include a flexible printed cable. Since the multiple switch integrated device integrates a power on/off switch, a mode converting switch, a zoom switch, a shutter switch and/or a slow shutter switch with one another, the structure and assembly procedure can be simplified.

### CROSS-REFERENCE TO RELATED APPLICATION

This application claims the benefit under 35 U.S.C. § 119(a) of Korean Patent Application No. 2004-16041, filed on Mar. 10, 2003, in the Korean Intellectual Property Office, the entire content of which is incorporated herein by reference in its entirety.

### BACKGROUND OF THE INVENTION

1. Field of the Invention

The present invention relates to a switch device of a digital camcorder, and more particularly, to a multiple switch integrated device of a digital camcorder which comprises therein a plurality of switches such as a power on/off switch, a mode converting switch, and a zoom switch.

2. Description of the Related Art

Generally, a digital camcorder comprises a central processing device for controlling operation of the camcorder and a plurality of switches for controlling the central processing device to perform corresponding functions according to the on/off state. The plurality of switches comprise a power on/off switch, a mode converting switch for converting between a camera mode and a VCR mode, and a zoom switch for controlling a photographing magnification of an object.

The switches each comprise a switch assembly attached to an outer casing of the camcorder to expose an operation button to the outside, and a flexible printed cable (FPC) for connecting the switch assembly to a socket formed on a main substrate constituting the central processing device.

Because the conventional camcorder has several FPCs to connect the respective switches to the corresponding sockets of the main substrate, its inner structure is complicated. Also, in assembling the switches, because it is required to attach the switch assemblies to the outer casing, respectively, and then connect the respective FPCs to the corresponding sockets of the main substrate, work efficiency during assembly deteriorates and thus production decreases.

Recently, consumers' diverse demands accelerate the development of a digital still camera-integrated camcorder that photographs an object, stores a still image signal in a memory card, and prints the image through a printer or reproduces it through a PC.

For operation of the digital still camera, in addition to the power on/off switch, the mode converting switch, and the zoom switch, the digital still camera-integrated camcorder has to have a shutter switch for photographing a still image and a slow shutter switch for performing a slow-Sync mode to adjust a timing point when a flash or a strobo fires according to a shutter speed.

Therefore, the digital still camera-integrated camcorder has a more complicated structure than the general camcorder due to the FPCs of the additional switches. Also, in assembling the switches, it is quite troublesome to assemble switch assemblies with an outer casing respectively and connect the FPCs to corresponding sockets of a substrate. Accordingly, work efficiency during assembly of a digital still camera-integrated camcorder is significantly less and thus production also significantly decreases.

### SUMMARY OF THE INVENTION

The present invention has been developed in order to solve the above problems in the related art. Accordingly, an aspect of the present invention is to provide a multiple switch integrated device of a digital camcorder which comprises therein a plurality of switches such as a power on/off switch, a mode converting switch, a zoom switch, a shutter switch and/or a slow shutter switch, thereby simplifying structure and assembly procedure.

The above aspect is achieved by providing a multiple switch integrated device of a digital camcorder which comprises a main substrate constituting a central processing device for controlling operation of the camcorder. The multiple switch integrated device comprises a switch unit which comprises: a plurality of switch assemblies mounted on an outer casing of the camcorder to expose their buttons to the outside for controlling the central processing device to perform functions corresponding to operations of the buttons; a plurality of first electric connection parts for electrically connecting the plurality of switch assemblies to one another in series; and a second electric connection part electrically connected with one of the plurality of switch assemblies and including a connection terminal connected to a socket formed on the main substrate.

In one embodiment, the plurality of switch assemblies comprises at least one of a power on/off and mode converting switch assembly for turning on/off power source and converting between a camera mode and a VCR mode, a zoom switch assembly for adjusting a photographing magnification of an object, a shutter switch assembly for photographing a still image, and a slow shutter switch assembly for performing a slow-Sync mode to adjust a timing point when a flash or a strobo fires according to a shutter speed. If the plurality of switch assemblies comprises the zoom switch assembly and the shutter switch assembly, the zoom switch assembly and the shutter switch assembly may be integrated with each other.

The first and the second electric connection parts may include a flexible printed cable.

The multiple switch integrated device may further comprise a switch mounting frame constituting a part of the outer casing and affixing the plurality of switch assemblies thereto.

### BRIEF DESCRIPTION OF THE DRAWING FIGURES

The above aspect and other advantages of the present invention will be more apparent by describing an embodiment of the present invention with reference to the accompanying drawing figures, in which:

FIG. 1 is a perspective view showing a digital camcorder employing a multiple switch integrated device according to an embodiment of the present invention;

FIG. 2 is an exploded perspective view showing the multiple switch integrated device of the digital camcorder of FIG. 1; and

FIG. 3 is a front view showing the multiple switch integrated device of FIG. 2 in an assembled state.

In the drawing figures, it will be understood that like reference numerals refer to like features and structures.

### DETAILED DESCRIPTION OF THE EXEMPLARY EMBODIMENTS

Hereinafter, a multiple switch integrated device of a digital camcorder according to an embodiment of the present invention will be described in greater detail with reference to the accompanying drawing figures.

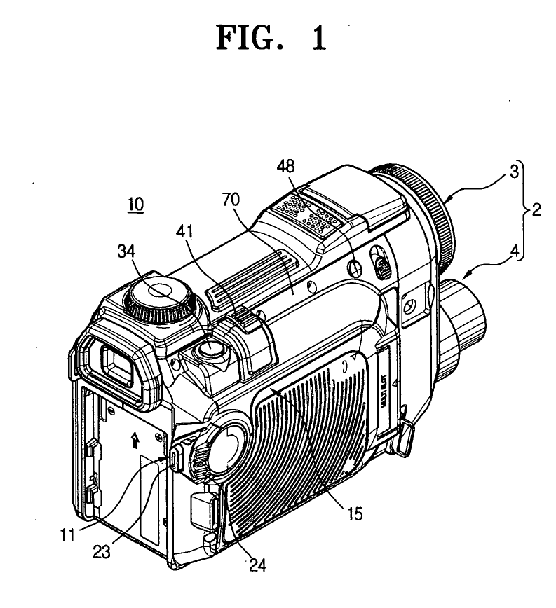

FIG. 1 illustrates a digital camcorder 10 employing a multiple switch integrated device according to an embodiment of the present invention.

The digital camcorder 10 comprises a camera unit 2 having a video camera part 3 for photographing a motion picture and a digital still camera part 4 for photographing a still picture, which are disposed on upper and lower portions of the camera unit 2 in an integrated manner, a main substrate (not shown) disposed in an outer casing 15 and constituting a central processing device for controlling operation of the camcorder, and a multiple switch integrated device 11 for controlling the central processing device to perform functions corresponding to operations of operation buttons 23, 24, 34, 41, 48.

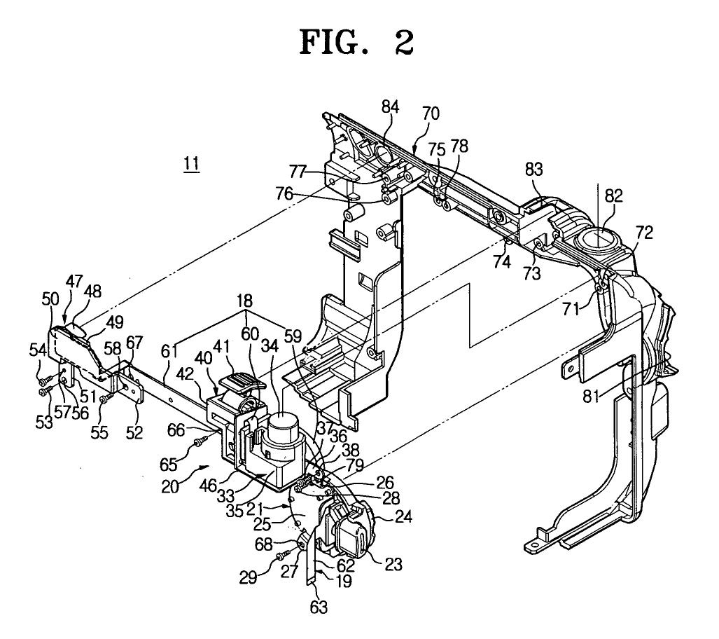

As shown in FIG. 2, the multiple switch integrated device 11 comprises a switch unit 20 and a switch mounting frame 70 which constitutes the outer casing 15 of the camcorder 10 and mounts the switch unit 20 thereon.

The switch unit 20 comprises: first, second, third and fourth switch assemblies 21, 33, 40, 47 for controlling the central processing device to perform the functions corresponding to the operations of the operation buttons 23, 24, 34, 41, 48; a first electric connection part 18 for electrically connecting the first, second, third and fourth switch assemblies 21, 33, 40, 47, respectively, to one another in series; and a second electric connection part 19 electrically connected to the first switch assembly 21 and having a connection terminal 63 connected to a socket (not shown) formed on the main substrate. The first through fourth switch assemblies 21, 33, 40, 47 are respectively mounted on the switch mounting frame 70 such that the operation buttons 23, 24, 34, 41, 48 are exposed to the outside.

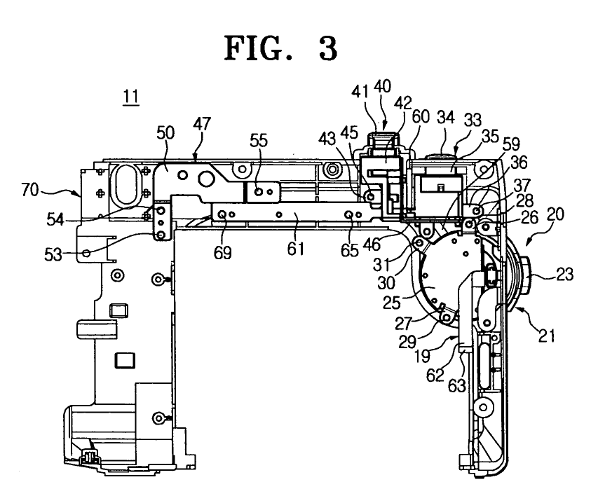

The first switch assembly 21 comprises a power on/off button 23 for turning on/off a power source located on a side surface of the switch mounting frame 70, a mode converting lever 24 disposed adjacent to the power on/off button 23 for converting between a selected one of a video camera mode, a VCR mode or a digital still camera mode, and a first body 25 including a well-known switching circuit (not shown) for transmitting a switch signal corresponding to operations of the power on/off button 23 and the mode converting lever 24 to the central processing device for controlling the central processing device to perform the corresponding functions. The first switch assembly 21 is fixed to the switch mounting frame 70 by three first fixing brackets 26, 27, 30 formed on the first body 25 and first fixing screws 28, 29, 31 (see FIG. 3), respectively, such that the power on/off button 23 and the mode converting lever 24 are exposed to the outside through a first opening 81 formed in the switch mounting frame 70.

The second switch assembly 33 comprises a shutter button 34 for photographing a still picture, and a second body 35 including a well-known switching circuit (not shown) for transmitting a switch signal corresponding to operation of the shutter button 34 to the central processing device to adjust a shutter of the digital still camera part 4. The second switch assembly 33 is fixed to the switch mounting frame 70 by a second fixing bracket 36 formed on the second body 35 and a second fixing screw 37 such that the shutter button 34 is exposed to the outside through a first hole 82 formed in the switch mounting frame 70.

The third switch assembly 40 comprises a zoom button 41 for adjusting a photographing magnification of an object, and a third body 42 including a well-known switching circuit (not shown) for transmitting a switch signal corresponding to operation of the zoom button 41 to the central processing device to adjust a photographing magnification of an object. The third assembly 40 is fixed to the switch mounting frame 70 by a third fixing bracket 43 (see FIG. 3) formed on the third body 42 and a third fixing screw 45 such that the zoom button 41 is exposed to the outside through a second opening 83 formed in the switch mounting frame 70.

Because the second switch assembly 33 and the third switch assembly 40 are disposed adjacent to each other, it is preferred that the second body 35 and the third body 42 are assembled integrally with each other by fixing means such as a fixing plate 46 and a fixing screw (not shown).

The fourth assembly 47 comprises a slow shutter button 48 for performing a slow-Sync mode to adjust a timing point when a flash or a strobo fires according to a shutter speed, and a fourth body 49 including a well-known switching circuit (not shown) for transmitting a switch signal corresponding to operation of the slow shutter button 48 to the central processing device to adjust a shutter speed of the digital still camera part 4. The fourth assembly 47 is fixed to the switch mounting frame 70 by two fourth fixing brackets 51, 52 formed on a support plate 50 for supporting the fourth body 49 and three fourth fixing screws 53, 54, 55 such that the slow shutter button 48 is exposed to the outside through a second hole 84 formed in the switch mounting frame 70.

The first electric connection part 18 comprises a first FPC 59 for connecting the switching circuits of the first and the second bodies 25 and 35 of the first and the second switch assemblies 21 and 33 to each other in series, a second FPC 60 for connecting the switching circuits of the second and the third bodies 35 and 42 of the second and the third switch assemblies 33 and 40 to each other in series, and a third FPC 61 for connecting the switching circuits of the third and the fourth bodies 42 and 49 of the third and the fourth switch assemblies 40 and 47 in series.

Because the third FPC 61 is longer than the first and the second FPCs 59 and 60, it is preferable that the third FPC 61 is fixed to the switch mounting frame 70 by inserting first and second FPC fixing screws 65 and 69 (see FIG. 3) in first and second FPC fixing holes 74 and 75 of the switch mounting frame 70 through first and second FPC penetrating holes 66 and 67 (see FIG. 2) so as not to cause interference in the assembling of other parts.

In another embodiment, the third FPC 61 is physically more robust and thicker than the first and the second FPCs 59 and 60 or has a supplementary part (not shown) to facilitate the fixing of the third FPC 61 to the switch mounting frame 70 by the first and the second FPC fixing screws 65 and 69.

The second electric connection part 19 comprises a fourth FPC 62 electrically connected to the switching circuit of the first body 25 of the first switch assembly 21 and including the connection terminal 63 connected to the socket (not shown) formed on the main substrate.

As described above, in the multiple switch integrated device 11 according to the present invention, since only the fourth FPC 62 is designed to include the connection terminal 63 connected to the socket formed on the main substrate, it has more simplified structure than the conventional switch, and also, the number of assembly procedures of connecting connection terminals of the FPCs to sockets of the main substrate is quite reduced.

Also, since the first, second, third and fourth switch assemblies 21, 33, 40, 47 are integrally connected to one another by the first, second and third FPCs 59, 60, 61, the first, second, third and fourth switch assemblies 21, 33, 40, 47 are not required to be picked up respectively during assembly. That is, since the first, second, third and fourth switch assemblies 21, 33, 40, 47 can be mounted on the switch mounting frame 70 at once by a single pick-up operation, assembly efficiency is improved.

Also, since the multiple switch integrated device 11 is configured such that the switch mounting frame 70 for mounting the first, second, third and fourth switch assemblies 21, 33, 40, 47 forms the outer casing 15, the multiple switch integrated device 10 can be previously prepared before assembly. Accordingly, the time to assembly the camcorder can be reduced.

Although the multiple switch integrated device 11 is applied to the digital still camera-integrated camcorder including a power on/off switch, a mode converting switch, a zoom switch, a shutter switch, and a slow shutter switch in this embodiment, this should not be considered as limiting. That is, the multiple switch integrated device 11 can be applied to a general digital camcorder, which does not integrate the digital still camera part 4 and includes only one or more of the power on/off switch, the mode converting switch, and the zoom switch.

Hereinafter, an assembly process of the multiple switch integrated device 11 as constructed above will be described with reference to FIGS. 2 and 3.

As shown in FIG. 2, the switch unit 20 in which the first, second, third and fourth switch assemblies 21, 33, 40, 47 are integrally connected to one another through the first, second and third FPCs 59, 60, 61 is prepared.

Next, the power on/off button 23 and the mode converting lever 24 of the first switch assembly 21, the shutter button 34 of the second switch assembly 33, the zoom button 41 of the third switch assembly 40, and the slow shutter button 48 of the fourth switch assembly 47 are inserted in the first opening 81, the first hole 82, the second opening 83 and the second hole 84. First penetrating holes 79 and 68 (only two of three first penetrating holes are illustrated in FIG. 2) of the first fixing brackets 26, 27, 30, a second penetrating hole 38 of the second fixing bracket 36, a third penetrating hole (not shown) of the third fixing bracket 43, and a fourth penetrating holes 56, 57, 58 of the fourth fixing brackets 51 and 52 are aligned with a first fixing hole 71 (only one is illustrated), a second fixing hole 72, a third fixing hole 73, and fourth fixing holes 76, 77, 78 formed in the switch mounting frame 70.

Next, the first fixing screws 28, 29, 31, the second fixing screw 37, the third fixing screw 45, and the fourth fixing screws 53, 54, 55 are securely inserted in the first fixing hole 71, the second fixing hole 72, the third fixing hole 73, and the fourth fixing holes 76, 77, 78, respectively, through the first penetrating holes 79 and 68, the second penetrating hole 38, the third penetrating hole, and the fourth penetrating holes 56, 57, 58. The first and the second FPC fixing screws 65 and 69 are secured to the first and the second FPC fixing holes 74 and 75 through the first and the second FPC penetrating holes 66 and 67. Accordingly, the first, second, third and fourth switch assemblies 21, 33, 40, 47 and the third FPC 61 are fixed to the switch mounting frame 70.

In this state, after the connection terminal 63 of the fourth FPC 62 is connected to the socket formed on the main substrate, the switch mounting unit 60 is assembled with the outer casing 15, thereby completing the assembly of the multiple switch integrated device 11.

As described above, since the multiple switch integrated device 11 of the digital camcorder integrates the power on/off switch, the mode converting switch, the zoom switch, the shutter switch and/or the slow shutter switch with one another, the structure and assembly procedure can be simplified.

The foregoing embodiment and advantages are merely exemplary and are not to be construed as limiting the present invention. The description of the present invention is intended to be illustrative, and not to limit the scope of the claims. Many alternatives, modifications, and variations will be apparent to those skilled in the art.

1. A multiple switch integrated device of a digital camcorder which comprises a main substrate constituting a central processing device for controlling operation of the camcorder, the multiple switch integrated device comprising a switch unit, the switch unit comprising:
a plurality of switch assemblies mounted on an outer casing of the camcorder to expose their buttons to the outside for controlling the central processing device to perform functions corresponding to operations of the buttons;
a plurality of first electric connection parts for electrically connecting the plurality of switch assemblies to one another in series; and
a second electric connection part electrically connected with one of the plurality of switch assemblies and comprising a connection terminal connected to a socket formed on the main substrate.

2. The multiple switch integrated device as claimed in claim 1, wherein the plurality of switch assemblies comprises at least one of a power on/off and mode converting switch assembly for turning on/off power source and converting between a selected one of a camera mode and a VCR mode, a zoom switch assembly for adjusting a photographing magnification of an object, a shutter switch assembly for photographing a still image, and a slow shutter switch assembly for performing a slow-Sync mode to adjust a timing point when a flash or a strobo fires according to a shutter speed.

3. The multiple switch integrated device as claimed in claim 2, wherein the zoom switch assembly and the shutter switch assembly are integrated with each other.

4. The multiple switch integrated device as claimed in claim 1, wherein at least one of the first electric connection parts and the second electric connection parts comprises a flexible printed cable.

5. The multiple switch integrated device as claimed in claim 1, further comprising a switch mounting frame constituting a part of the outer casing for affixing the plurality of switch assemblies thereto.

6. A method of operating a multiple switch integrated device of a digital camcorder which comprises a main substrate constituting a central processing device for controlling operation of the camcorder, the method comprising the steps of:
mounting a plurality of switch assemblies on an outer casing of the camcorder to expose their buttons to the outside for controlling the central processing device to perform functions corresponding to operations of the buttons;
electrically connecting the plurality of switch assemblies to one another in series via a plurality of first electric connection parts; and
electrically connecting with one of the plurality of switch assemblies via a second electric connection part.

7. The method as claimed in claim 6, wherein the second electric connection part comprises a connection terminal connected to a socket formed on the main substrate.

8. The method as claimed in claim 6, wherein the plurality of switch assemblies comprises at least one of a power on/off and mode converting switch assembly for turning on/off power source and converting between a selected one of a camera mode and a VCR mode, a zoom switch assembly for adjusting a photographing magnification of an object, a shutter switch assembly for photographing a still image, and a slow shutter switch assembly for performing a slow-Sync mode to adjust a timing point when a flash or a strobo fires according to a shutter speed.

9. The method as claimed in claim 7, wherein the zoom switch assembly and the shutter switch assembly are integrated with each other.

10. The multiple switch integrated device as claimed in claim 6, wherein at least one of the first electric connection parts and the second electric connection parts comprises a flexible printed cable.

11. The method as claimed in claim 6, wherein a switch mounting frame constitutes a part of the outer casing and further comprising the step of affixing the plurality of switch assemblies to the outer casing via the switch mounting frame.
